(19) United States
(12) Patent Application Publication
(10) Pub. No.: US 2011/0240387 A1
(43) Pub. Date: Oct. 6, 2011

(54) THERMAL STRAIN REDUCING MOUNTING BRACKETS FOR A HEAT EXCHANGER

(75) Inventor: Alfred Piggott, Redford, MI (US)

(73) Assignee: DENSO International America, Inc., Southfield, MI (US)

(21) Appl. No.: 12/751,863

(22) Filed: Mar. 31, 2010

(51) Int. Cl. B60K 11/04

(52) U.S. Cl. 180/68.4

(57) ABSTRACT

A bracket for retaining a heat exchanger includes a base member having a first end portion and a second end portion. An aperture at the first end portion of the base member receives a fastener. The bracket is fixedly secured to a vehicle through the fastener. An arcuate hook at the second end of the base member receives the heat exchanger. A flex zone extends between the first and second end portions of the base member. The flex zone is movable between a first, relaxed position and a second, flexed position.

### FIELD

The present disclosure relates to heat exchangers, and more particularly, to thermal strain reducing mounting brackets for heat exchangers.

### BACKGROUND

This section provides background information related to the present disclosure which is not necessarily prior art. Heat exchangers may be used to cool liquids that are continuously circulated through heat generating devices on a vehicle. For example, a turbocharger uses exhaust gases to compress air, which are then circulated through a charge air cooler to be cooled to improve horsepower and fuel economy, while reducing emissions. Similarly, a vehicle air-conditioning system may compress a refrigerant, which is then cooled by passing through a multi-cooler.

The rate at which heating and cooling occurs depends upon the temperature, flow rate, and quantity of heat of incoming liquid supplied into and through the material of the heat exchanger relative to the temperature and rate of change of the temperature of external airflow. While external airflow may be delivered to the heat exchanger through either natural flow and/or with the assistance of a fan, the material of the heat exchanger may still increase in temperature over time. These increases in temperature may result in thermal stress at specific locations of the heat exchanger, specifically at constrained locations.

Thermal stress occurs as a result of the expansion and contraction of the material of the heat exchanger during heating and cooling cycles with respect to constrained locations. For example, fasteners are typically used to restrain the heat exchanger to a fixed location in an engine compartment, and thus, the heat exchanger may experience thermal stress near the fastener location. In another example, two heat exchangers having differing thermal expansion rates may be mounted together (e.g., such as the charge air cooler and the multi-cooler). Thermal stress may build at the mounting points due to expansion differences between the two heat exchangers.

Previous designs have incorporated rubber grommets at constrained locations to obviate thermal stresses, as thermal stresses can lead to durability issues. While rubber grommets can flex to allow the heat exchanger to slide relative to the fasteners or other heat exchanger, what is needed is a structure for improving durability, recyclability, and rigidity of the heat exchangers while still reducing thermal stress, complexity, and cost.

### SUMMARY

This section provides a general summary of the disclosure, and is not a comprehensive disclosure of its full scope or all of its features.

A bracket for retaining a heat exchanger includes a base member having a first end portion and a second end portion. An aperture at the first end portion of the base member receives a fastener. The bracket is fixedly secured to a vehicle through the fastener. An arcuate hook at the second end of the base member receives the heat exchanger. A flex zone extends between the first and second end portions of the base member. The flex zone is movable between a first, relaxed position and a second, flexed position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle depicting the location of an engine and heat exchanger in accordance with the present disclosure;

FIG. 2 is a front view of a charge air cooler and a multi-cooler depicting a location of a mounting bracket in accordance with the present disclosure;

FIG. 3 is an exploded view of a portion of FIG. 2;

FIG. 4A is a plan view showing the mounting bracket in accordance with the present disclosure;

FIG. 4B is a front view of the mounting bracket of FIG. 4A;

FIG. 5A is a front view showing the mounting bracket in accordance with another embodiment of the present disclosure;

FIG. 5B is a plan view of the mounting bracket of FIG. 5A;

FIG. 6 is a front view showing the mounting bracket in accordance with another embodiment of the present disclosure;

FIG. 7 is a front view showing the mounting bracket in accordance with another embodiment of the present disclosure;

FIG. 8 is a front view showing the mounting bracket in accordance with another embodiment of the present disclosure;

FIG. 9 is a front view showing the mounting bracket in accordance with another embodiment of the present disclosure;

FIG. 10 is a front view showing the mounting bracket in accordance with another embodiment of the present disclosure;

FIG. 11 is a front view showing the mounting bracket in accordance with another embodiment of the present disclosure;

FIG. 12 is a front view showing the mounting bracket in accordance with another embodiment of the present disclosure;

FIG. 13 is a front view showing the mounting bracket in accordance with another embodiment of the present disclosure;

FIG. 14 is a front view showing the mounting bracket in accordance with another embodiment of the present disclosure;

FIG. 15 is a front view showing the mounting bracket in accordance with another embodiment of the present disclosure;

FIG. 16 is a front view showing the mounting bracket in accordance with another embodiment of the present disclosure;

FIG. 17 is a front view showing the mounting bracket in accordance with another embodiment of the present disclosure;

FIG. 18 is a front view showing the mounting bracket in accordance with another embodiment of the present disclosure;

FIG. 19 is a front view showing the mounting bracket in accordance with another embodiment of the present disclosure;

FIG. 20 is a front view showing the mounting bracket in accordance with another embodiment of the present disclosure;

FIG. 21 is a front view showing the mounting bracket in accordance with another embodiment of the present disclosure;

FIG. 22 is a front view showing the mounting bracket in accordance with another embodiment of the present disclosure;

FIG. 23 is a front view showing the mounting bracket in accordance with another embodiment of the present disclosure;

FIG. 24 is a front view showing the mounting bracket in accordance with another embodiment of the present disclosure;

FIG. 25 is a front view showing the mounting bracket in accordance with another embodiment of the present disclosure;

FIG. 26 is a front view showing the mounting bracket in accordance with another embodiment of the present disclosure;

FIG. 27 is a front view showing the mounting bracket in accordance with another embodiment of the present disclosure;

FIG. 28 is a front view showing the mounting bracket in accordance with another embodiment of the present disclosure;

FIG. 29A is a plan view showing the mounting bracket in accordance with the present disclosure;

FIG. 29B is a front view of the mounting bracket of FIG. 29A;

FIG. 30A is a plan view showing the mounting bracket in accordance with the present disclosure;

FIG. 30B is a front view of the mounting bracket of FIG. 30A;

FIG. 31A is a plan view showing the mounting bracket in accordance with the present disclosure;

FIG. 31B is a front view of the mounting bracket of FIG. 31A;

FIG. 32A is a plan view showing the mounting bracket in accordance with the present disclosure; and

FIG. 32B is a front view of the mounting bracket of FIG. 32A.

Corresponding reference numerals indicate corresponding parts throughout the several views of the drawings.

### DETAILED DESCRIPTION

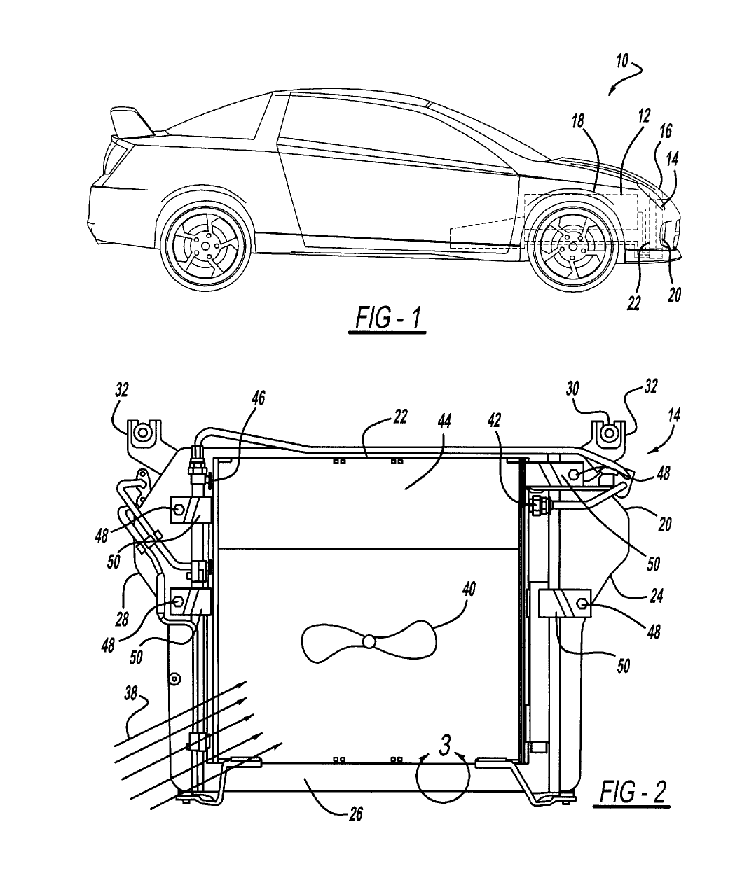

Example embodiments will now be described more fully with reference to FIGS. 1-32 of the accompanying drawings. It should be understood that throughout the drawings, corresponding reference numerals indicate like or corresponding parts and features. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies will not be described in detail.

Referring now to FIG. 1, a motor vehicle 10 (e.g., automobile) may be equipped with an engine 12 and a heat exchanger assembly 14. Heat exchanger assembly 14 may be fixedly secured to a frame member 16 of motor vehicle 10 within an engine compartment 18. While the following description refers to heat exchanger assembly 14 as including a charge air cooler 20 and a multi-cooler 22, it should be understood that the teachings of the present disclosure may also be applicable to other types of heat exchangers. For example, the present disclosure may be applicable to transmission cooler heat exchangers (i.e., for cooling transmission fluid of an automatic transmission), heater core heat exchangers (i.e., for transferring heat to a passenger compartment of a vehicle), vehicle air conditioning system heat exchangers (i.e., for reducing the temperature of an internal refrigerant, in liquid and/or gaseous phase), and refrigerant coolers (e.g., power steering cooler, engine oil cooler, EGR cooler). Additionally, the teachings of the present disclosure may be applicable whether such heat exchangers are made of metal, plastic, or any other material known in the art.

With reference now to FIGS. 2 and 3, heat exchanger assembly 14 may include charge air cooler 20 fixedly secured to multi-cooler 22. Charge air cooler 20 and multi-cooler 22 may be positioned so as to meet space constraints within engine compartment 18 and so as to make combined use of heat removing devices. Charge air cooler 20 may include an inlet manifold 24 for receiving heated and compressed air, a main core 26 for cooling the compressed air, and an outlet manifold 28 for expelling the cooled air. Charge air cooler 20 may be secured to a location within engine compartment 18 through a plurality of fasteners 30 (e.g., bolts) extending through a plurality of mounting brackets 32.

In an isochoric cooling operation, exhaust gases exiting engine 12 are heated and compressed as they pass through a turbocharger or a supercharger (not depicted). The heated and compressed air may then be delivered to inlet manifold 24 of charge air cooler 20 where it may be evenly distributed to main core 26. Main core 26 may incorporate a plurality of tubes or channels 34 surrounded by a plurality of ribs or fins 36. As compressed air flows through channels 34 of main core 26, heat may be expelled through fins 36. External airflow delivered to charge air cooler 20 through either natural flow (as depicted by arrows 38) and/or through a mechanical device, such as by a fan 40, may also assist in removing heat from main core 26. The compressed and newly cooled air may then be passed to outlet manifold 28 before being introduced to engine 12.

Similarly to charge air cooler 20, multi-cooler 22 may include an inlet 42 for receiving a heated coolant (i.e., oil), a main core 44 for cooling the coolant, and an outlet 46 for expelling the cooled coolant. Multi-cooler 22 may be secured to charge air cooler 20 through a plurality of fasteners 48 (e.g., bolts) extending through a plurality of mounting brackets 50. As in the cooling operation described with respect to charge air cooler 20, main core 44 of multi-cooler 22 may remove heat from the coolant through the use of channels 34 and fins 36. As should be understood, however, multi-cooler 22 may expel heat at a different rate than that of charge air cooler 20.

Both charge air cooler 20 and multi-cooler 22 may experience temperature fluctuations after repeated operation and as the temperature in engine compartment 18 rises. The rate at which heating and cooling occurs depends upon the temperature, flow rate, and quantity of heat of incoming liquid supplied into and through the material of charge air cooler 20 and multi-cooler 22 relative to the temperature and rate of change of the external temperature. Increases in temperature may result in thermal expansion of certain components of charge air cooler 20 and multi-cooler 22, while decreases in temperature may result in thermal constriction of these same components.

Further, these temperature fluctuations may vary between charge air cooler 20 and multi-cooler 22 because of the alternate component designs and various materials flowing therethrough. These fluctuations may result in thermal stress at specific locations of charge air cooler 20 and multi-cooler 22, particularly at constrained locations, such as near mounting fasteners 30, 48 and brackets 32, 50. In the present embodiment, however, mounting brackets 32, 50 may allow for controlled movement between charge air cooler 20 and frame member 16 and between charge air cooler 20 and multi-cooler 22, thereby alleviating these thermal stresses.

While the embodiments are described hereinafter with respect to mounting bracket 50, it should be understood that the principles of the designs are also applicable to mounting bracket 32. It should also be understood that while mounting bracket 50 is depicted at all locations joining charge air cooler 20 and multi-cooler 22, a standard bracket (not shown) may be substituted for mounting bracket 50 at any of these locations.

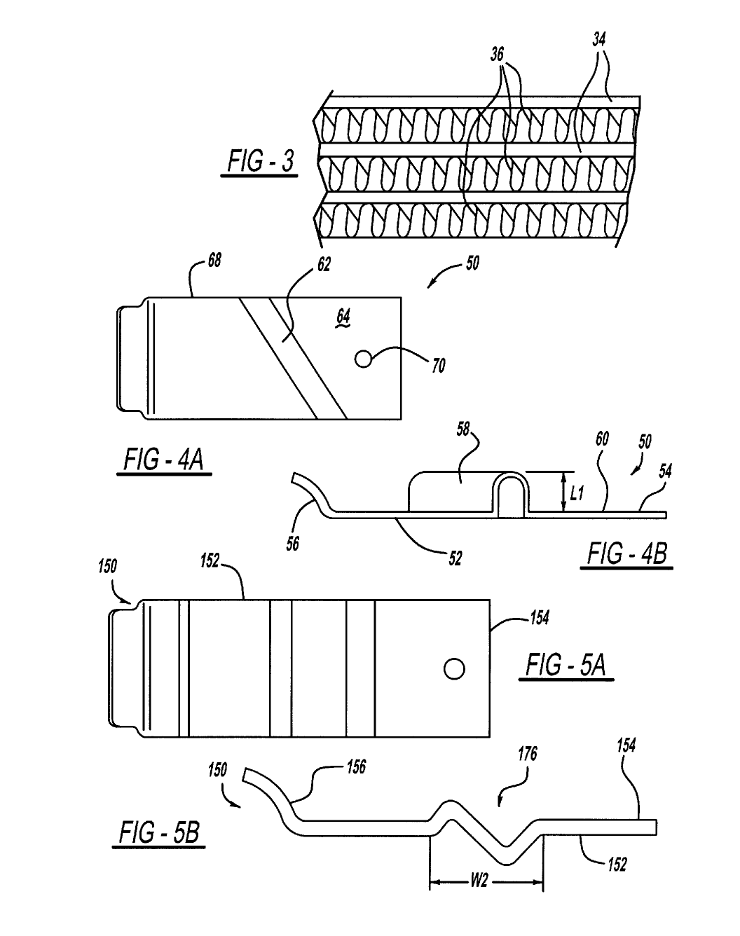

Referring now to FIGS. 4A and 4B, a first embodiment for mounting bracket 50 is depicted having a substantially straight base 52 extending from a fastener-receiving end 54 to an arcuate hook end 56. A u-shaped expansion portion 58 extends a predetermined distance L1 from an upper surface 60 of base 52, so as to provide a channel or concavity 62 along a lower surface 64 of mounting bracket 50. Concavity 62 extends in a diagonal arrangement from a first side 66 of base 52 to a second side 68 of base 52.

Mounting bracket 50 may be fixedly secured to charge air cooler 20 by mounting fastener 48 extending through an aperture 70 at fastener-receiving end 54. Additionally, arcuate hook end 56 may contact multi-cooler 22 so as to hold multi-cooler 22 laterally relative to charge air cooler 20 while still allowing some flexion as multi-cooler 22 and/or charge air cooler 20 expand and contract.

As charge air cooler 20 and multi-cooler 22 expand and contract, thermal stress experienced at fastener-receiving end 54 and arcuate hook end 56 may be absorbed along the length of mounting bracket 50. In particular, expansion portion 58 may be configured so as to deform to absorb the tension and/or compression stresses generated along the length of mounting bracket 50. Additionally, the diagonal arrangement of expansion portion 58 allows mounting bracket 50 to absorb the tension and/or compression stresses generated perpendicular to the length of mounting bracket 50. Thus, the thermal stresses are reduced and/or eliminated, thereby increasing durability and rigidity.

Additionally, a flange structure (not shown) may extend a distance from upper surface 60 at sides 66, 68 of base 52 and at points along the length from fastener-receiving end 54 to arcuate hook end 56 to provide added strength and stability to mounting bracket 50. Flange structure (not shown) may extend continuously along sides of base 52 or may be strategically located to strengthen particular features of base 52. It should be understood that flange structure (not shown) may also be incorporated to any other of the following stamped bracket designs (e.g., FIGS. 4, and 29 through 32).

Another embodiment of the disclosure will be described with reference to FIGS. 5A and 5B and a mounting bracket 150. Like or similar parts to those of the first embodiment are designated by like or similar reference numerals and will not be described in detail herein.

Mounting bracket 150 may have a base 152 extending from a fastener-receiving end 154 to an arcuate hook end 156. A flex zone 176 bridges fastener-receiving end 154 to arcuate hook end 156. Flex zone 176 is depicted as a diagonal slide extending over a predetermined distance W2. Flex zone 176 allows base 152 to extend linearly between fastener-receiving end 154 and arcuate hook end 156.

Mounting bracket 150 may be secured to charge air cooler 20 and multi-cooler 22 as previously described with respect to mounting bracket 50 so as to absorb thermal stresses along the length of mounting bracket 150. In particular, flex zone 176 is configured so as to deform to absorb the tension and/or compression stresses generated along the length of mounting bracket 150. Additionally, the diagonal bend of flex zone 176 allows mounting bracket 150 to absorb the tension and/or compression stresses generated perpendicular to the length of mounting bracket 150. Thus, the thermal stresses are reduced and/or eliminated, thereby increasing durability and rigidity.

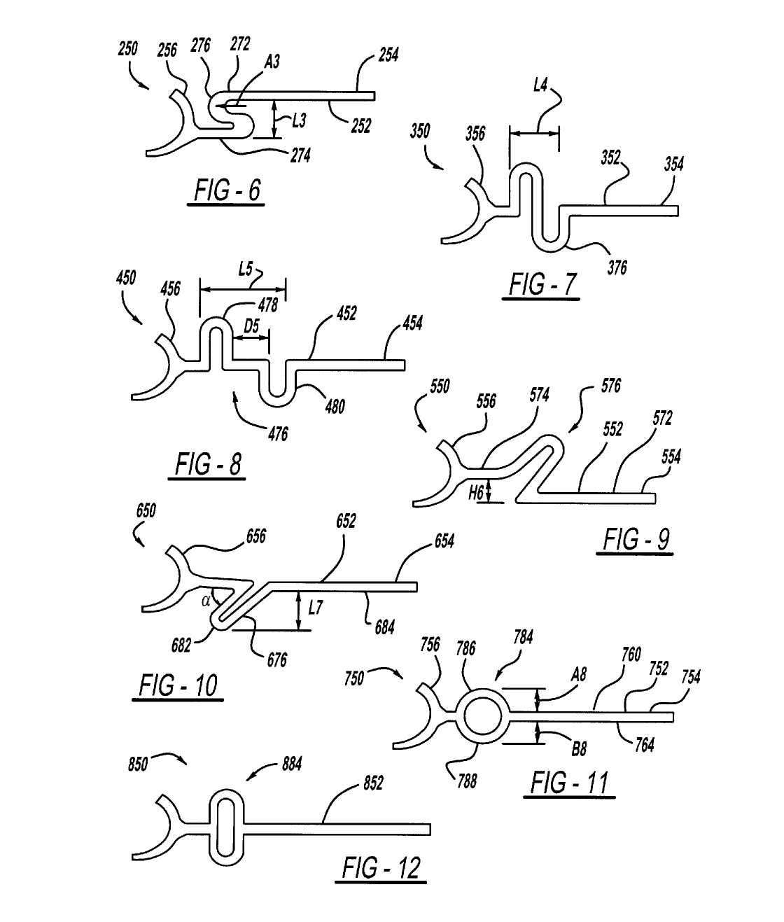

Another embodiment of the disclosure will be described with reference to FIG. 6 and a mounting bracket 250. Like or similar parts to those of the first embodiment are designated by like or similar reference numerals and will not be described in detail herein.

Mounting bracket 250 may have a rounded step base 252 extending from a fastener-receiving end 254 to an arcuate hook end 256. Arcuate hook end 256 may be brazed to rounded step base 252 as shown or may be bolted as is known in the art. Rounded step base 252 may have an upper step 272 at fastener-receiving end 254 and a lower step 274 at arcuate hook end 256 separated by a distance L3. A flex zone 276 bridges upper step 272 to lower step 274. Flex zone 276 is depicted as an s-shaped or double rounded portion extending over a predetermined distance A3.

Mounting bracket 250 may be secured to charge air cooler 20 and multi-cooler 22 as previously described with respect to mounting bracket 50 so as to absorb thermal stresses along the length of mounting bracket 250. In particular, flex zone 276 is configured so as to deform to absorb the tension and/or compression stresses generated along the length of mounting bracket 250. Additionally, the pleated arrangement of flex zone 276 allows mounting bracket 250 to absorb the tension and/or compression stresses generated perpendicular to the length of mounting bracket 250. Thus, the thermal stresses are reduced and/or eliminated, thereby increasing durability and rigidity.

Another embodiment of the disclosure will be described with reference to FIG. 7 and a mounting bracket 350. Like or similar parts to those of the first embodiment are designated by like or similar reference numerals and will not be described in detail herein.

As can be seen, mounting bracket 350 is substantially similar to mounting bracket 250 depicted in FIG. 6 except that flex zone 276 has been rotated by approximately 90 degrees to form a flex zone 376. This rotation allows a base 352 to extend linearly between a fastener-receiving end 354 and an arcuate hook end 356. Flex zone 376 bridges fastener-receiving end 354 and arcuate hook end 356 over a predetermined length L4.

Mounting bracket 350 may be secured to charge air cooler 20 and multi-cooler 22 as previously described with respect to mounting bracket 50 so as to absorb thermal stresses along the length of mounting bracket 350. In particular, flex zone 376 is configured so as to deform to absorb the tension and/or compression stresses generated along the length of mounting bracket 350. Additionally, the pleated arrangement of flex zone 376 allows mounting bracket 350 to absorb the tension and/or compression stresses generated perpendicular to the length of mounting bracket 350. Thus, the thermal stresses are reduced and/or eliminated, thereby increasing durability and rigidity.

Another embodiment of the disclosure will be described with reference to FIG. 8 and a mounting bracket 450. Like or similar parts to those of the first embodiment are designated by like or similar reference numerals and will not be described in detail herein.

As can be seen, mounting bracket 450 is substantially similar to mounting bracket 350 depicted in FIG. 7 except that a flex zone 476 has been divided into an upper zone 478 and a lower zone 480 separated by a distance D5. This provides more flexibility for a base 452 to absorb the tension and/or compression stress generated perpendicular to the length of mounting bracket 450 while still providing increased rigidity in the lateral direction. Flex zone 476 bridges a fastener-receiving end 454 and an arcuate hook end 456 over a predetermined overall length L5.

Mounting bracket 450 may be secured to charge air cooler 20 and multi-cooler 22 as previously described with respect to mounting bracket 50 so as to absorb thermal stresses along the length of mounting bracket 450. In particular, flex zone 476 is configured so as to deform to absorb the tension and/or compression stresses generated along the length of mounting bracket 450. Additionally, the pleated arrangement of flex zone 476 allows mounting bracket 450 to absorb the tension and/or compression stresses generated perpendicular to the length of mounting bracket 450. Thus, the thermal stresses are reduced and/or eliminated, thereby increasing durability and rigidity.

Another embodiment of the disclosure will be described with reference to FIG. 9 and a mounting bracket 550. Like or similar parts to those of the first embodiment are designated by like or similar reference numerals and will not be described in detail herein.

Mounting bracket 550 may have a stepped base 552 extending from a fastener-receiving end 554 to an arcuate hook end 556. Stepped base 552 has a lower step 572 at fastener-receiving end 554 and an upper step 574 at arcuate hook end 556 separated by a distance H6. A flex zone 576 bridges lower step 572 to upper step 574 in a substantially z-shaped configuration.

Mounting bracket 550 may be secured to charge air cooler 20 and multi-cooler 22 as previously described with respect to mounting bracket 50 so as to absorb thermal stresses along the length of mounting bracket 550. In particular, flex zone 576 is configured so as to deform to absorb the tension and/or compression stresses generated along the length of mounting bracket 550. Additionally, the pleated arrangement of flex zone 576 allows mounting bracket 550 to absorb the tension and/or compression stresses generated perpendicular to the length of mounting bracket 550. Thus, the thermal stresses are reduced and/or eliminated, thereby increasing durability and rigidity.

Another embodiment of the disclosure will be described with reference to FIG. 10 and a mounting bracket 650. Like or similar parts to those of the first embodiment are designated by like or similar reference numerals and will not be described in detail herein.

As can be seen, mounting bracket 650 is substantially similar to mounting bracket 550 depicted in FIG. 9 except that a base 652 is not stepped, but instead extends linearly from a fastener-receiving end 654 to an arcuate hook end 656. A flex zone 676 bridges fastener-receiving end 654 to arcuate hook end 656 such that an extension member 682 extends at an angle α from a lower surface 684 of base 652 by a distance L7.

Mounting bracket 650 may be secured to charge air cooler 20 and multi-cooler 22 as previously described with respect to mounting bracket 50 so as to absorb thermal stresses along the length of mounting bracket 650. In particular, flex zone 676 is configured so as to deform to absorb the tension and/or compression stresses generated along the length of mounting bracket 650. Additionally, the angled arrangement of flex zone 676 allows mounting bracket 650 to absorb the tension and/or compression stresses generated perpendicular to the length of mounting bracket 650. Thus, the thermal stresses are reduced and/or eliminated, thereby increasing durability and rigidity.

Another embodiment of the disclosure will be described with reference to FIG. 11 and a mounting bracket 750. Like or similar parts to those of the first embodiment are designated by like or similar reference numerals and will not be described in detail herein.

Mounting bracket 750 may have a base 752 extending from a fastener-receiving end 754 to an arcuate hook end 756. Base 752 may be divided near arcuate hook end 756 so as to form an expansion portion 784. Expansion portion 784 may be a substantially double-arc configuration such that an upper portion 786 extends at a predetermined distance A8 from an upper surface 760 of base 752 and a lower portion 788 extends at a predetermined distance B8 from a lower surface 764 of base 752. The distances A8 and B8 may be similar or may be varied to increase flexibility of mounting bracket 750 in a particular direction (e.g., a “flatter” arc will allow less movement).

Mounting bracket 750 may be secured to charge air cooler 20 and multi-cooler 22 as previously described with respect to mounting bracket 50 so as to absorb thermal stresses along the length of mounting bracket 750. In particular, expansion portion 784 is configured so as to deform to absorb the tension and/or compression stresses generated along the length of mounting bracket 750. Additionally, the divided arrangement of expansion portion 784 between base 752 allows mounting bracket 750 to absorb the tension and/or compression stresses generated perpendicular to the length of mounting bracket 750. Thus, the thermal stresses are reduced and/or eliminated, thereby increasing durability and rigidity.

Another embodiment of the disclosure will be described with reference to FIG. 12 and a mounting bracket 850. Like or similar parts to those of the first embodiment are designated by like or similar reference numerals and will not be described in detail herein.

As can be seen, mounting bracket 850 is substantially similar to mounting bracket 750 depicted in FIG. 11 except that an expansion portion 884 is depicted in a substantially ovular configuration. This provides more rigidity for a base 852 with respect to the tension and/or compression stress generated perpendicular to the length of mounting bracket 850 while still providing increased rigidity in the lateral direction. Thus, the thermal stresses are reduced and/or eliminated, thereby increasing durability and rigidity.

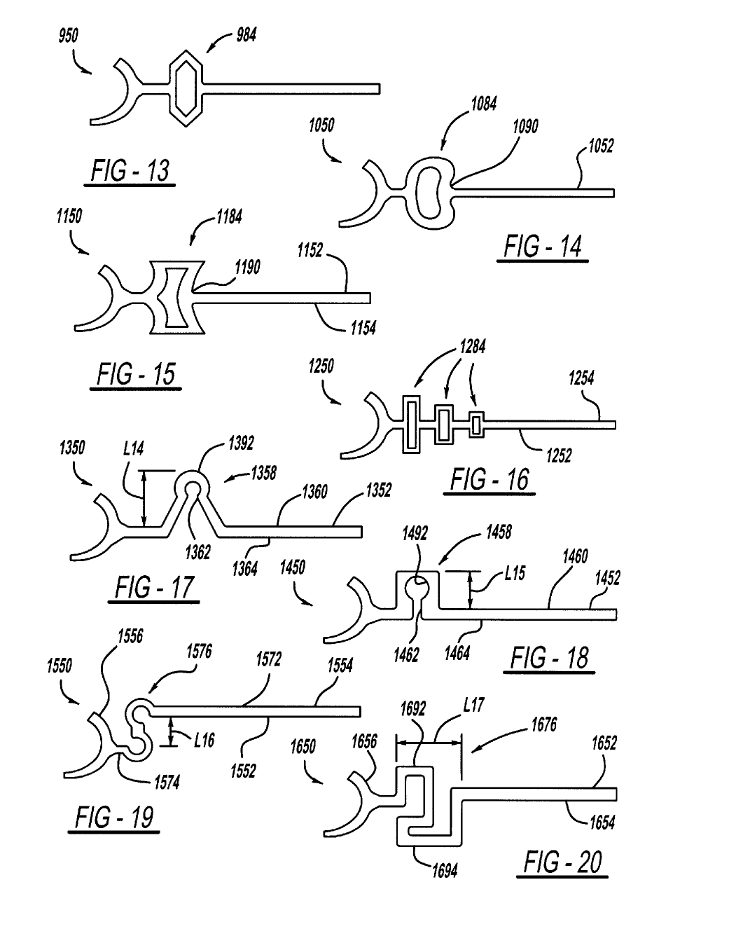

Another embodiment of the disclosure will be described with reference to FIG. 13 and a mounting bracket 950. Like or similar parts to those of the first embodiment are designated by like or similar reference numerals and will not be described in detail herein.

As can be seen, mounting bracket 950 is substantially similar to mounting bracket 750 depicted in FIG. 11 except that an expansion portion 984 is depicted in a substantially diamond-shaped configuration. This pleated arrangement in expansion portion 984 allows mounting bracket 950 to absorb the tension and/or compression stresses generated perpendicular to the length of mounting bracket 950. Thus, the thermal stresses are reduced and/or eliminated, thereby increasing durability and rigidity.

Another embodiment of the disclosure will be described with reference to FIG. 14 and a mounting bracket 1050. Like or similar parts to those of the first embodiment are designated by like or similar reference numerals and will not be described in detail herein.

As can be seen, mounting bracket 1050 is substantially similar to mounting bracket 750 depicted in FIG. 11 except that an expansion portion 1084 is depicted in a substantially kidney-shaped configuration. This provides rigidity for a base 1052 with respect to the tension and/or compression stress generated perpendicular to the length of mounting bracket 1050 while still providing increased rigidity in the lateral direction. An inverted portion 1090 nearest a fastener-receiving end 1054 of base 1052 may provide greater lateral movement for charge air cooler 20 than multi-cooler 22. Thus, the thermal stresses are reduced and/or eliminated, thereby increasing durability and rigidity.

Another embodiment of the disclosure will be described with reference to FIG. 15 and a mounting bracket 1150. Like or similar parts to those of the first embodiment are designated by like or similar reference numerals and will not be described in detail herein.

As can be seen, mounting bracket 1150 is substantially similar to mounting bracket 750 depicted in FIG. 11 except that an expansion portion 1184 is depicted in a substantially bowed rectangular configuration. This provides rigidity for a base 1152 with respect to the tension and/or compression stress generated perpendicular to the length of mounting bracket 1150 while still providing increased rigidity in the lateral direction. An inverted portion 1190 nearest a fastener-receiving end 1154 of base 1152 may provide greater lateral movement for charge air cooler 20 than multi-cooler 22. Thus, the thermal stresses are reduced and/or eliminated, thereby increasing durability and rigidity.

Another embodiment of the disclosure will be described with reference to FIG. 16 and a mounting bracket 1250. Like or similar parts to those of the first embodiment are designated by like or similar reference numerals and will not be described in detail herein.

As can be seen, mounting bracket 1250 is substantially similar to mounting bracket 750 depicted in FIG. 11 except that multiple expansion portions 1284 are depicted in a decreasing size relationship nearest a fastener-receiving end 1254 of a base 1252. Expansion portions 1284 may have a substantially rectangular configuration for providing rigidity for base 1252 with respect to the tension and/or compression stress generated perpendicular to the length of mounting bracket 1250 while still providing increased rigidity in the lateral direction. The decreasing size relationship of expansion portions 1284 may provide increased rigidity for base 1252 nearest fastener-receiving end 1254. Thus, the thermal stresses are reduced and/or eliminated, thereby increasing durability and rigidity.

Another embodiment of the disclosure will be described with reference to FIG. 17 and a mounting bracket 1350. Like or similar parts to those of the first embodiment are designated by like or similar reference numerals and will not be described in detail herein.

As can be seen, mounting bracket 1350 is substantially similar to mounting bracket 50 depicted in FIGS. 4A and 4B except having a triangular, key-hole configuration expansion portion 1358 extending a predetermined distance L14 from an upper surface 1360 of a base 1352. Key-hole expansion portion 1358 provides a channel or concavity 1362 along a lower surface 1364 of mounting bracket 1350. Concavity 1362 extends across the length of base 1352. An uppermost end 1392 of key-hole expansion portion 1358 is substantially rounded so as to alleviate any potential for stress risers at this location.

Mounting bracket 1350 may be secured to charge air cooler 20 and multi-cooler 22 as previously described with respect to mounting bracket 50 so as to absorb thermal stresses along the length of mounting bracket 1350. In particular, uppermost end 1392 of key-hole expansion portion 1358 is configured so as to deform to absorb the tension and/or compression stresses generated along the length of mounting bracket 1350. Thus, the thermal stresses are reduced and/or eliminated, thereby increasing durability and rigidity.

Another embodiment of the disclosure will be described with reference to FIG. 18 and a mounting bracket 1450. Like or similar parts to those of the first embodiment are designated by like or similar reference numerals and will not be described in detail herein.

As can be seen, mounting bracket 1450 is substantially similar to mounting bracket 1350 depicted in FIG. 17 except having an outer squared configuration expansion portion 1458 extending a predetermined distance L15 from an upper surface 1460 of a base 1452. Expansion portion 1458 provides a key-hole channel or concavity 1462 along a lower surface 1464 of mounting bracket 1450. Key-hole concavity 1462 extends across the length of base 1452. A lower end 1492 of key-hole concavity 1462 is substantially rounded so as to alleviate any potential for stress risers at this location.

Mounting bracket 1450 may be secured to charge air cooler 20 and multi-cooler 22 as previously described with respect to mounting bracket 50 so as to absorb thermal stresses along the length of mounting bracket 1450. In particular, lower end 1492 of key-hole concavity 1462 is configured so as to deform to absorb the tension and/or compression stresses generated along the length of mounting bracket 1450. Thus, the thermal stresses are reduced and/or eliminated, thereby increasing durability and rigidity.

Another embodiment of the disclosure will be described with reference to FIG. 19 and a mounting bracket 1550. As can be seen, mounting bracket 1550 incorporates many of the features previously described above with respect to the other embodiments. Accordingly, like or similar parts to the other embodiments are designated by like or similar reference numerals and will not be described in detail herein.

Mounting bracket 1550 may have a rounded step base 1552 extending from a fastener-receiving end 1554 to an arcuate hook end 1556. Rounded step base 1552 may have an upper step 1572 at fastener-receiving end 1554 and a lower step 1574 at arcuate hook end 1556 separated by a distance L16. A flex zone 1576 bridges upper step 1572 to lower step 1574. Flex zone 1576 is depicted as a double key-hole portion joined in a substantially s-shape.

Mounting bracket 1550 may be secured to charge air cooler 20 and multi-cooler 22 as previously described with respect to mounting bracket 50 so as to absorb thermal stresses along the length of mounting bracket 1550. In particular, flex zone 1576 is configured so as to deform to absorb the tension and/or compression stresses generated along the length of mounting bracket 1550. Additionally, double key-hole arrangement of flex zone 1576 allows mounting bracket 1550 to absorb the tension and/or compression stresses generated perpendicular to the length of mounting bracket 1550. Thus, the thermal stresses are reduced and/or eliminated, thereby increasing durability and rigidity.

Another embodiment of the disclosure will be described with reference to FIG. 20 and a mounting bracket 1650. As can be seen, mounting bracket 1650 incorporates many of the features previously described above with respect to the other embodiments. Accordingly, like or similar parts to the other embodiments are designated by like or similar reference numerals and will not be described in detail herein.

Mounting bracket 1650 is substantially similar to mounting bracket 350 depicted in FIG. 7 except that flex zone 376 has been squared to form a flex zone 1676 having a first lobe 1692 and a second lobe 1694. This squared lobe configuration allows a base 1652 to extend in a controlled fashion between a fastener-receiving end 1654 and an arcuate hook end 1656. Flex zone 1676 bridges fastener-receiving end 1654 and arcuate hook end 1656 over a predetermined length L17.

Mounting bracket 1650 may be secured to charge air cooler 20 and multi-cooler 22 as previously described with respect to mounting bracket 50 so as to absorb thermal stresses along the length of mounting bracket 1650. In particular, first lobe 1692 of flex zone 1676 is configured so as to deform to absorb the tension and/or compression stresses generated along the length of mounting bracket 1650. Additionally, second lobe 1694 of flex zone 1676 allows mounting bracket 1650 to absorb the tension and/or compression stresses generated perpendicular to the length of mounting bracket 1650. Thus, the thermal stresses are reduced and/or eliminated, thereby increasing durability and rigidity.

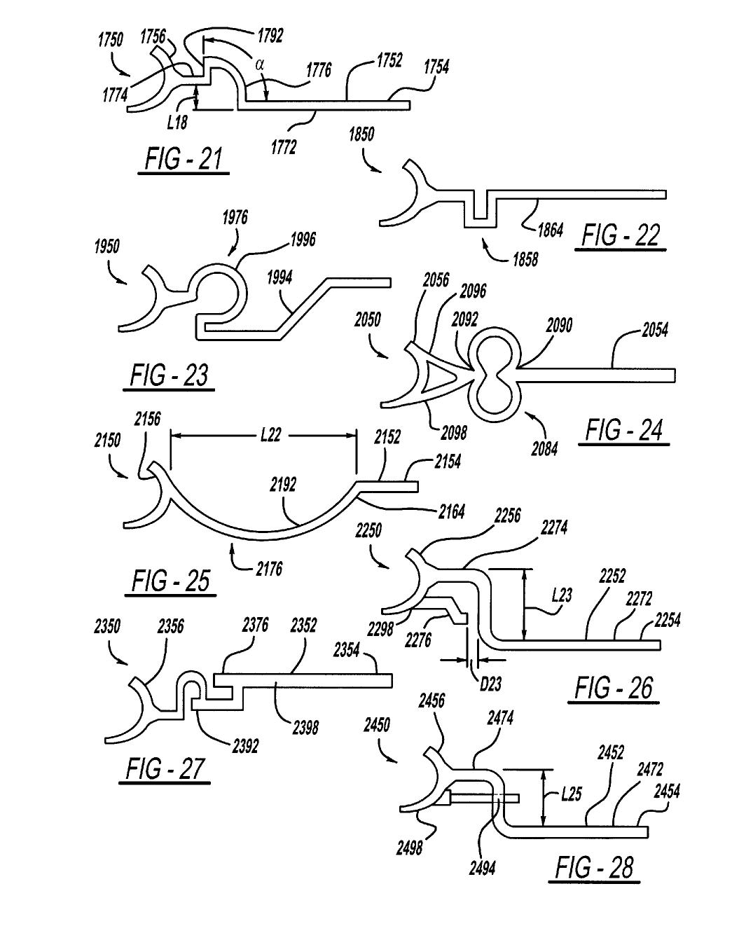

Another embodiment of the disclosure will be described with reference to FIG. 21 and a mounting bracket 1750. As can be seen, mounting bracket 1750 incorporates many of the features previously described above with respect to the other embodiments. Accordingly, like or similar parts to the other embodiments are designated by like or similar reference numerals and will not be described in detail herein.

Mounting bracket 1750 may have a rounded step base 1752 extending from a fastener-receiving end 1754 to an arcuate hook end 1756. Rounded step base 1752 has a lower step 1772 at fastener-receiving end 1754 and an upper step 1774 at arcuate hook end 1756 separated by a distance L18. A flex zone 1776 bridges lower step 1772 to upper step 1774. Flex zone 1776 is depicted as an arc a extending from lower step 1772 and terminating at a vertical extension member 1792.

Mounting bracket 1750 may be secured to charge air cooler 20 and multi-cooler 22 as previously described with respect to mounting bracket 50 so as to absorb thermal stresses along the length of mounting bracket 1750. In particular, flex zone 1776 is configured so as to deform to absorb the tension and/or compression stresses generated along the length of mounting bracket 1750. Additionally, the stepped arrangement of flex zone 1776 allows mounting bracket 1750 to absorb the tension and/or compression stresses generated perpendicular to the length of mounting bracket 1750. Thus, the thermal stresses are reduced and/or eliminated, thereby increasing durability and rigidity.

Another embodiment of the disclosure will be described with reference to FIG. 22 and a mounting bracket 1850. As can be seen, mounting bracket 1850 incorporates many of the features previously described above with respect to the other embodiments. Accordingly, like or similar parts to the other embodiments are designated by like or similar reference numerals and will not be described in detail herein.

Mounting bracket 1850 is substantially similar to mounting bracket 1450 depicted in FIG. 18 except having an expansion portion 1858 omitting key-hole concavity 1462. Further, expansion portion 1858 extends from a lower surface 1864 of mounting bracket 1850.

Mounting bracket 1850 may be secured to charge air cooler 20 and multi-cooler 22 as previously described with respect to mounting bracket 50 so as to absorb thermal stresses along the length of mounting bracket 1850. In particular, expansion portion 1858 is configured so as to deform to absorb the tension and/or compression stresses generated along the length of mounting bracket 1850. Additionally, the reversed arrangement of expansion portion 1858 (e.g., extending from lower surface 1864) allows mounting bracket 1850 to deflect certain tension and/or compression stresses generated perpendicular to the length of mounting bracket 1850. Thus, the thermal stresses are reduced and/or eliminated, thereby increasing durability and rigidity.

Another embodiment of the disclosure will be described with reference to FIG. 23 and a mounting bracket 1950. As can be seen, mounting bracket 1950 incorporates many of the features previously described above with respect to the other embodiments. Accordingly, like or similar parts to the other embodiments are designated by like or similar reference numerals and will not be described in detail herein.

Mounting bracket 1950 incorporates a flex zone 1976 having a diagonal slide 1994 and a key-hole loop 1996 such as flex zone 176 and key-hole expansion portion 1358 from mounting brackets 150, 1350 depicted in FIGS. 5 and 17. Mounting bracket 1950 may be secured to charge air cooler 20 and multi-cooler 22 as previously described with respect to mounting bracket 50 so as to absorb thermal stresses along the length of mounting bracket 1950. In particular, key-hole loop 1996 is substantially rounded so as to alleviate any potential for stress risers at this location and so as to deform to absorb the tension and/or compression stresses generated along the length of mounting bracket 1950. Additionally, the stepped arrangement of flex zone 1976 allows mounting bracket 1950 to absorb the tension and/or compression stresses generated perpendicular to the length of mounting bracket 1950. Thus, the thermal stresses are reduced and/or eliminated, thereby increasing durability and rigidity.

Another embodiment of the disclosure will be described with reference to FIG. 24 and a mounting bracket 2050. As can be seen, mounting bracket 2050 incorporates many of the features previously described above with respect to the other embodiments. Accordingly, like or similar parts to the other embodiments are designated by like or similar reference numerals and will not be described in detail herein.

Mounting bracket 2050 is substantially similar to mounting bracket 1050 depicted in FIG. 14 except having an alternate configuration expansion portion 2084. Expansion portion 2084 includes a first inverted portion 2090 nearest a fastener-receiving end 2054 of mounting bracket 2050 and a second inverted portion 2092 nearest an arcuate hook end 2056 of mounting bracket 2050. Further, a length of mounting bracket 2050 extending between expansion portion 2084 and arcuate hook end 2056 is split to terminate at an upper end 2096 of arcuate hook end 2056 and at a lower end 2098 of arcuate hook end 2056. This provides rigidity for mounting bracket 2050 with respect to the tension and/or compression stress generated perpendicular to the length of mounting bracket 2050 while still providing increased rigidity in the lateral direction. Inverted portions 2090, 2092 and the split at arcuate hook end 2056 may provide greater lateral movement for charge air cooler 20 than multi-cooler 22. Thus, the thermal stresses are reduced and/or eliminated, thereby increasing durability and rigidity.

Another embodiment of the disclosure will be described with reference to FIG. 25 and a mounting bracket 2150. As can be seen, mounting bracket 2150 incorporates many of the features previously described above with respect to the other embodiments. Accordingly, like or similar parts to the other embodiments are designated by like or similar reference numerals and will not be described in detail herein.

Mounting bracket 2150 may have a flex zone 2176 bridging a fastener-receiving end 2154 to an arcuate hook end 2156. Flex zone 2176 is depicted as a bowed portion 2192 extending from a lower surface 2164 of a base 2152 of mounting bracket 2150 over a predetermined distance L22. Mounting bracket 2150 may be secured to charge air cooler 20 and multi-cooler 22 as previously described with respect to mounting bracket 50 so as to absorb thermal stresses along the length of mounting bracket 2150. In particular, flex zone 2176 is configured so as to deform to absorb the tension and/or compression stresses generated along the length of mounting bracket 2150. Additionally, the curved arrangement of bowed portion 2192 allows mounting bracket 2150 to absorb the tension and/or compression stresses generated perpendicular to the length of mounting bracket 2150. Thus, the thermal stresses are reduced and/or eliminated, thereby increasing durability and rigidity.

Another embodiment of the disclosure will be described with reference to FIG. 26 and a mounting bracket 2250. As can be seen, mounting bracket 2250 incorporates many of the features previously described above with respect to the other embodiments. Accordingly, like or similar parts to the other embodiments are designated by like or similar reference numerals and will not be described in detail herein.

Mounting bracket 2250 may have a stepped base 2252 extending from a fastener-receiving end 2254 to an arcuate hook end 2256. Stepped base 2252 has a lower step 2272 at fastener-receiving end 2254 and an upper step 2274 at arcuate hook end 2256 separated by a distance L23. A bend limiter 2276 extends from a lower surface 2298 of arcuate hook end 2256, terminating a predetermined distance D23 from stepped base 2252.

Mounting bracket 2250 may be secured to charge air cooler 20 and multi-cooler 22 as previously described with respect to mounting bracket 50 so as to absorb thermal stresses along the length of mounting bracket 2250. Further, bend limiter 2276 is configured so as to allow controlled deformation of mounting bracket 2250 to absorb the tension and/or compression stresses generated along the length of mounting bracket 2250. Additionally, stepped arrangement of base 2252 allows mounting bracket 2250 to absorb the tension and/or compression stresses generated perpendicular to the length of mounting bracket 2250. Thus, the thermal stresses are reduced and/or eliminated, thereby increasing durability and rigidity.

Another embodiment of the disclosure will be described with reference to FIG. 27 and a mounting bracket 2350. As can be seen, mounting bracket 2350 incorporates many of the features previously described above with respect to the other embodiments. Accordingly, like or similar parts to the other embodiments are designated by like or similar reference numerals and will not be described in detail herein.

Mounting bracket 2350 is substantially similar to mounting bracket 2250 depicted in FIG. 26 except incorporating a first limiter 2376 nearest a fastener-receiving end 2354 and a second limiter 2392 nearest an arcuate hook end 2356. Mounting bracket 2350 may have a stepped base 2352 extending from fastener-receiving end 2354 to arcuate hook end 2356. First limiter 2376 extends coplanar from fastener-receiving end 2354 of base 2352, while second limiter 2392 extends from a lower surface 2398 of base 2352. Limiters 2376, 2392 work in conjunction to allow controlled deformation of mounting bracket 2350 to absorb the tension and/or compression stresses generated along the length of mounting bracket 2350. Additionally, stepped arrangement of base 2352 allows mounting bracket 2350 to absorb the tension and/or compression stresses generated perpendicular to the length of mounting bracket 2350. Thus, the thermal stresses are reduced and/or eliminated, thereby increasing durability and rigidity.

Another embodiment of the disclosure will be described with reference to FIG. 28 and a mounting bracket 2450. As can be seen, mounting bracket 2450 incorporates many of the features previously described above with respect to the other embodiments. Accordingly, like or similar parts to the other embodiments are designated by like or similar reference numerals and will not be described in detail herein.

Mounting bracket 2450 is substantially similar to mounting bracket 2250 depicted in FIG. 26 except incorporating at least one sliding guide or pin 2492 in place of bend limiter 2276. Mounting bracket 2450 may have a stepped base 2452 extending from a fastener-receiving end 2454 to an arcuate hook end 2456. Stepped base 2452 has a lower step 2472 at fastener-receiving end 2454 and an upper step 2474 at arcuate hook end 2456 separated by a distance L25. The at least one sliding pin 2492 extends from a lower surface 2498 of arcuate hook end 2456 and extends through an aperture 2494 in stepped base 2452.

Mounting bracket 2450 may be secured to charge air cooler 20 and multi-cooler 22 as previously described with respect to mounting bracket 50 so as to absorb thermal stresses along the length of mounting bracket 2450. Further, sliding pin 2492 is configured so as to allow controlled deformation of mounting bracket 2450 to absorb the tension and/or compression stresses generated along the length of mounting bracket 2450. Additionally, stepped arrangement of base 2452 allows mounting bracket 2450 to absorb the tension and/or compression stresses generated perpendicular to the length of mounting bracket 2450. It should be noted, however, that configuration of aperture 2494 may limit the ability of mounting bracket 2450 to absorb the tension and/or compression stresses generated perpendicular to the length of mounting bracket 2450. Sliding pin 2492 and aperture 2494 arrangement, however, does add rigidity to mounting bracket 2450 in a direction transverse to the length of base 2452.

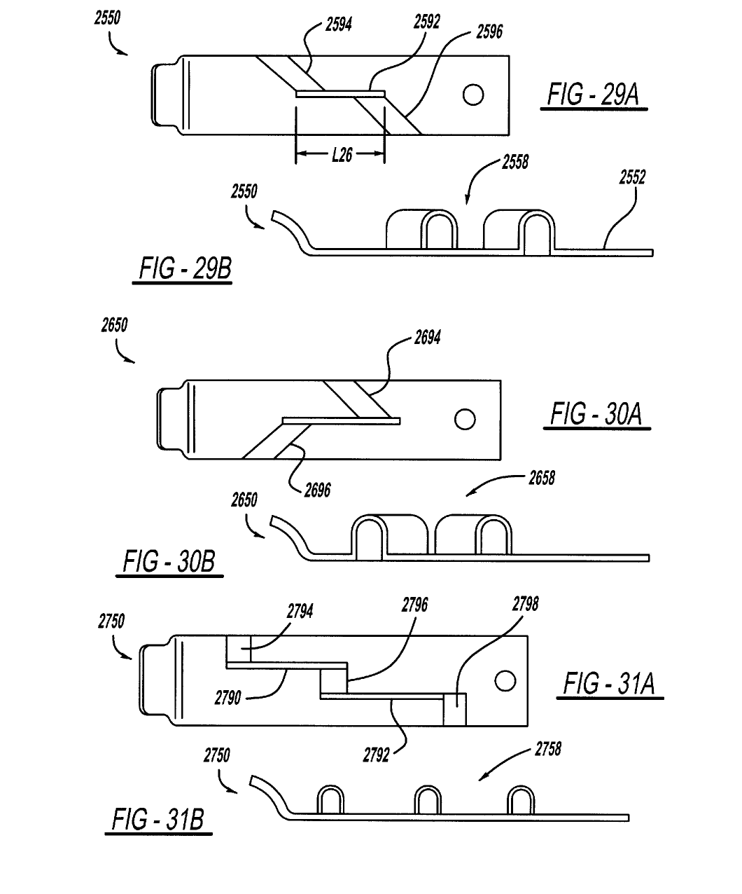

Another embodiment of the disclosure will be described with reference to FIGS. 29A and 29B and a mounting bracket 2550. As can be seen, mounting bracket 2550 incorporates many of the features previously described above with respect to the other embodiments. Accordingly, like or similar parts to the other embodiments are designated by like or similar reference numerals and will not be described in detail herein.

Mounting bracket 2550 is substantially similar to mounting bracket 50 depicted in FIGS. 4A and 4B except having an alternate configuration expansion portion 2558. Expansion portion 2558 is bisected and staggered at a central rectangular opening 2592 to form a first expansion channel 2594 and a second expansion channel 2596. Central opening 2592 extends over a length L26 of a base 2552 of mounting bracket 2550. This provides rigidity for base 2552 with respect to the tension and/or compression stress generated perpendicular to the length of mounting bracket 2550 while still providing increased rigidity in the lateral direction. The split at central opening 2592 may provide greater lateral movement for charge air cooler 20 than multi-cooler 22. Additionally, the diagonal arrangement of expansion portion 2558 allows mounting bracket 2550 to absorb the tension and/or compression stresses generated perpendicular to the length of mounting bracket 2550. Thus, the thermal stresses are reduced and/or eliminated, thereby increasing durability and rigidity.

Another embodiment of the disclosure will be described with reference to FIGS. 30A and 30B and a mounting bracket 2650. As can be seen, mounting bracket 2650 incorporates many of the features previously described above with respect to the other embodiments. Accordingly, like or similar parts to the other embodiments are designated by like or similar reference numerals and will not be described in detail herein.

Mounting bracket 2650 is substantially similar to mounting bracket 2550 depicted in FIGS. 29A and 29B except having an alternate configuration expansion portion 2658. In particular, a second expansion channel 2696 is inverted so as to form a staggered vee-configuration with a first expansion channel 2694. The staggered vee-configuration of expansion portion 2658 allows mounting bracket 2650 to absorb the tension and/or compression stresses generated perpendicular to the length of mounting bracket 2650. Thus, the thermal stresses are reduced and/or eliminated, thereby increasing durability and rigidity.

Another embodiment of the disclosure will be described with reference to FIGS. 31A and 31B and a mounting bracket 2750. As can be seen, mounting bracket 2750 incorporates many of the features previously described above with respect to the other embodiments. Accordingly, like or similar parts to the other embodiments are designated by like or similar reference numerals and will not be described in detail herein.

Mounting bracket 2750 incorporates a transverse expansion portion 2758 that is split and staggered at a first and second central opening 2790, 2792 so as to form a first, second, and third expansion channel 2794, 2796, 2798 spaced evenly on mounting bracket 2750. Mounting bracket 2750 may be secured to charge air cooler 20 and multi-cooler 22 as previously described with respect to mounting bracket 50 so as to absorb thermal stresses along the length of mounting bracket 2750. The transverse, staggered configuration of expansion portion 2758 allows mounting bracket 2750 to absorb the tension and/or compression stresses generated perpendicular to the length of mounting bracket 2750. Thus, the thermal stresses are reduced and/or eliminated, thereby increasing durability and rigidity.

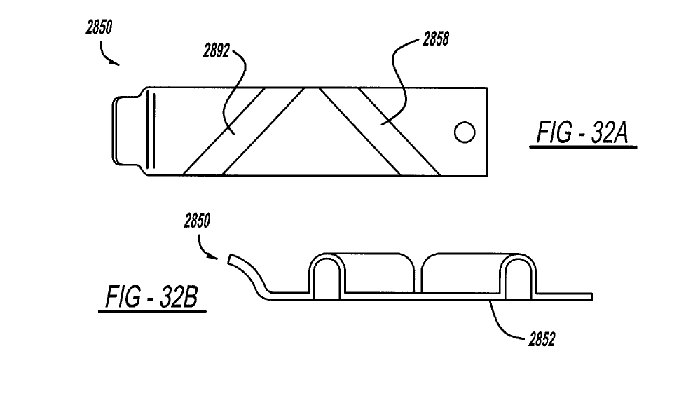

Another embodiment of the disclosure will be described with reference to FIGS. 32A and 32B and a mounting bracket 2850. As can be seen, mounting bracket 2850 incorporates many of the features previously described above with respect to the other embodiments. Accordingly, like or similar parts to the other embodiments are designated by like or similar reference numerals and will not be described in detail herein.

Mounting bracket 2850 is substantially similar to mounting bracket 50 depicted in FIGS. 4A and 4B except having an alternate configuration expansion portion 2858. Expansion portion 2858 is mirrored to provide a second expansion portion 2892 along the length of a base 2852 of mounting bracket 2850. This provides rigidity for base 2852 with respect to the tension and/or compression stress generated perpendicular to the length of mounting bracket 2850 while still providing increased rigidity in the lateral direction. Thus, the thermal stresses are reduced and/or eliminated, thereby increasing durability and rigidity.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A bracket for retaining a heat exchanger, comprising:
a base member having a first end portion coplanar with a second end portion;
an aperture at the first end portion of the base member for receiving a fastener, the bracket fixedly secured to a vehicle through the fastener;
an arcuate hook at the second end portion of the base member for receiving the heat exchanger; and
a flex zone extending between the first and second end portions of the base member, the flex zone movable between a first, relaxed position and a second, flexed position.

2. The bracket according to claim 1 wherein the first end portion of the base member is fixedly secured to a second heat exchanger.

3. The bracket according to claim 1 further comprising:
at least one expansion portion extending from a first surface of the base member and forming a second surface concavity along a second surface of the base member, the first and second surfaces in an opposing relationship.

4. The bracket according to claim 3 wherein the at least one expansion portion extends diagonally across a mid-portion of the base member.

5. The bracket according to claim 4 wherein a rectangular opening in the base member bisects the at least one expansion portion.

6. The bracket according to claim 3 wherein the at least one expansion portion extends transversely across a mid-portion of the base member.

7. The bracket according to claim 4 wherein at least one rectangular opening in the base member divides the at least one expansion portion.

8. The bracket according to claim 3 wherein the concavity terminates in a key-hole having a rounded channel.

9. The bracket according to claim 3 further comprising:
at least one expansion portion extending from the second surface of the base member and forming a first surface concavity along the first surface of the base member.

10. The bracket according to claim 9 wherein the first surface concavity and the second surface concavity form one of a polygonal shape.

11. The bracket according to claim 10 wherein the polygonal shape is one of a double-arc, an oval, a diamond, a kidney, a FIG. 8, and a rectangle.

12. A bracket for retaining a heat exchanger, comprising:
a base member having a first end portion parallel with a second end portion;
an aperture at the first end portion of the base member for receiving a fastener, the bracket fixedly secured to a vehicle through the fastener;
an arcuate hook at the second end portion of the base member for receiving the heat exchanger; and
a flex zone joining the first and second end portions of the base member, the flex zone movable between a first, relaxed position and a second, flexed position.

13. The bracket according to claim 12 wherein the first end portion of the base member is fixedly secured to a second heat exchanger.

14. The bracket according to claim 12 further comprising:
at least one expansion portion extending from a first surface of the base member and forming a second surface concavity along a second surface of the base member, the first and second surfaces in an opposing relationship.

15. The bracket according to claim 14 wherein the at least one expansion portion extends diagonally across a mid-portion of the base member.

16. The bracket according to claim 14 wherein the at least one expansion portion extends transversely across a mid-portion of the base member.

17. The bracket according to claim 14 wherein the concavity terminates in a key-hole having a rounded channel.

18. The bracket according to claim 14 further comprising:
at least one expansion portion extending from the second surface of the base member and forming a first surface concavity along the first surface of the base member.

19. The bracket according to claim 12 further comprising:
a limiter extending from the arcuate hook, the limiter contacting the flex zone in the second, flexed position.

20. The bracket according to claim 12 further comprising:
at least one sliding pin extending from the arcuate hook, the at least one sliding pin extending through a corresponding aperture in the flex zone.
